(19) United States
(12) Patent Application Publication
(10) Pub. No.: US 2025/0323860 A1
(43) Pub. Date: Oct. 16, 2025

(54) HARDWARE-IMPLEMENTED TOPOLOGICAL ALGORITHM GENERATOR FOR NETWORK TRAFFIC OPTIMIZATION

(71) Applicants: PRAVEEN VADDADI, Bangalore, IN (US); PRANEETH VADDADI, Bangalore (IN)

(72) Inventors: PRAVEEN VADDADI, Bangalore, IN (US); PRANEETH VADDADI, Bangalore (IN)

(21) Appl. No.: 19/096,714

(22) Filed: Apr. 1, 2025

Related U.S. Application Data
(63) Continuation-in-part of application No. 17/871,769, filed on Jul. 22, 2022, now abandoned.

(51) Int. Cl. H04L 45/00; H04L 43/08

(52) U.S. Cl. CPC H04L 45/22; H04L 43/08

(57) ABSTRACT

The algorithm development process begins by receiving ontology information defining aspects of a problem domain, the ontology information including a list of types and associated attributes. This information is then transformed into homological descriptions. A chain complex is created based on mathematical postulates, wherein the chain complex satisfies predefined homomorphism rules. The system computes a basis for the chain complex. The basis is partitioned into an input set and an instruction set to define a synthesized algorithm. The synthesized algorithm is added to an algorithm knowledge base. Finally, the synthesized algorithm is executed to solve a problem in the problem domain.

### CLAIM OF PRIORITY

This application is a continuation of part of U.S. patent application Ser. No. 17/871,769, filed on Jul. 22, 2022. This application is hereby incorporated by reference in its entirety.

### BACKGROUND

The development of computational algorithms has traditionally been a human-centered process, relying heavily on programmer intuition, experience, and trial-and-error approaches. This conventional paradigm of algorithm development has remained largely unchanged since the inception of computer programming, presenting several significant limitations in addressing the growing complexity of modern computational challenges.

Conventional approaches to algorithm development typically involve manual design and implementation by human programmers, who construct algorithms based on their understanding of the problem domain and existing algorithmic paradigms. These approaches are inherently constrained by human cognitive limitations, making it difficult to discover novel algorithmic solutions that may exist beyond established patterns of thought. Furthermore, the process is often time-consuming, labor-intensive, and prone to errors, particularly for complex problem domains where the optimal solution may not be readily apparent through intuitive reasoning.

Current techniques for automating algorithm discovery and optimization, such as genetic programming, reinforcement learning, and other machine learning approaches, have shown promise in specific domains. However, these approaches typically rely on statistical sampling of solution spaces or incremental modifications to existing solutions, rather than a principled mathematical exploration of the underlying structure of algorithmic spaces. Consequently, these techniques often struggle with efficiently discovering algorithms for complex problems with large or non-convex solution spaces and may fail to identify novel algorithmic paradigms that lie outside the patterns represented in their training data or search spaces.

Network traffic management presents a particularly challenging domain for algorithm development. Modern networks must handle increasingly diverse traffic patterns, quality-of-service requirements, security threats, and rapidly changing conditions. Traditional network management algorithms are often designed for specific network configurations or traffic patterns and struggle to adapt to the dynamic nature of contemporary network environments. Human-designed algorithms for network traffic management typically make simplifying assumptions about network behavior that limit their effectiveness in complex, real-world scenarios.

Furthermore, existing approaches to network algorithm development typically treat routing, congestion control, quality-of-service management, and security as separate concerns with distinct algorithmic solutions. This fragmented approach fails to capture the inherent interconnections between these aspects of network behavior, leading to suboptimal overall network performance. The increasing complexity of network environments, coupled with the growing diversity of applications and their requirements, has created a need for more sophisticated, adaptive, and holistic algorithms for network traffic management.

Recent advances in applied mathematics, particularly in the field of algebraic topology, have opened new possibilities for understanding complex systems through their structural and relational properties. Algebraic topology provides mathematical tools for analyzing the global properties of spaces based on their local connectivity, offering a powerful framework for representing and reasoning about complex relational structures. While these mathematical tools have found applications in various fields, including data analysis, sensor networks, and computational biology, their potential for automated algorithm discovery and generation remains largely unexplored.

There exists a need for a systematic, mathematically rigorous approach to algorithm discovery that can overcome the limitations of human intuition and current automated techniques. Such an approach should enable the exploration of the full space of possible algorithmic solutions, facilitate the discovery of novel algorithmic paradigms, and provide a unified framework for addressing complex, multifaceted problems such as network traffic management. Additionally, there is a need for methods that can continuously learn from and build upon discovered algorithms, creating a cumulative knowledge base that enhances future algorithm discovery processes.

The present invention addresses these needs by providing a method and system for algorithm synthesis using algebraic topological techniques, with particular application to network traffic management and other complex computational domains. The invention establishes a new paradigm for algorithm development that bridges the gap between abstract mathematical structures and practical, executable algorithms, enabling the discovery of novel algorithmic solutions beyond the reach of conventional human-centered approaches.

### SUMMARY OF THE INVENTION

In one aspect, an algorithm development process begins by receiving ontology information that defines aspects of a problem domain, including a comprehensive list of types and their associated attributes. This information is then systematically transformed into homological descriptions, enabling mathematical representation of the domain knowledge. Following this transformation, a chain complex is created based on robust mathematical postulates, carefully constructed to satisfy predefined homomorphism rules that ensure structural integrity. Once established, the system computes a basis for the chain complex, providing foundational elements for algorithm synthesis. The basis is then strategically partitioned into an input set and an instruction set, effectively defining a synthesized algorithm that captures the essential operations needed. This newly created algorithm is added to an algorithm knowledge base, expanding the system's capabilities through a feedback loop characteristic of cybernetic systems. Finally, the synthesized algorithm is executed to solve specific problems within the original problem domain, demonstrating the cybernetic principles of self-regulation and adaptive response to environmental conditions through this continuous cycle of knowledge acquisition, transformation, and application.

### BRIEF DESCRIPTION OF THE DRAWINGS

The present application can be best understood by reference to the following description taken in conjunction with the accompanying figures, in which like parts may be referred to by like numerals.

FIG. 1 illustrates an example process for implementing an algorithm synthesis using algebraic topological techniques, according to some embodiments.

FIG. 2 illustrates an example process for the initialization routine and/or bootstrap process, according to some embodiments.

FIG. 3 illustrates an example process for implementing a containerized algorithm discovery/synthesis system, according to some embodiments.

FIG. 4 illustrates an example system for implementing an algorithm synthesizer on one or more knowledge component inputs, according to some embodiments.

FIG. 5 illustrates an example process, according to some embodiments.

FIG. 6 describes an example process providing for the generation of algorithms from first principles.

FIG. 7 illustrates an example process for combining algorithms to form computational systems, according to some embodiments.

FIG. 8 illustrates an example process of algorithm synthetization, according to some embodiments.

FIG. 9 illustrates an example process for hardware-implemented topological algorithm generator for network traffic optimization, according to some embodiments.

FIG. 10 illustrates an example system of an example System Architecture and Implementation for process 900, according to some embodiments.

FIG. 11 illustrates an example process for applications in Network Traffic Management, according to some embodiments.

FIG. 12 illustrates an example hardware system for implementing hardware-implemented topological algorithm generator for network traffic optimization, according to some embodiments.

FIG. 13 depicts an exemplary computing system that can be configured to perform any one of the processes provided herein.

The Figures described above are a representative set and are not exhaustive with respect to embodying the invention.

### DESCRIPTION

Disclosed are a system, method, and article of manufacture for algorithm synthesis using algebraic topological techniques. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Abstract algebra is the study of algebraic structures. Algebraic structures include, inter alia: groups, rings, fields, modules, vector spaces, lattices, algebras, etc.

Algebraic topology is a branch of mathematics that uses tools from abstract algebra to study topological spaces. Algebraic topology seeks to find algebraic invariants that classify topological spaces up to homeomorphism.

Algorithm can be a finite sequence of rigorous instructions, typically used to solve a class of specific problems or to perform a computation.

Container (e.g. OS-level virtualization) can be a virtual runtime environment that runs on top of an operating-system kernel and emulates an operating system (e.g. rather than an underlying hardware).

Cybernetics is concerned with regulatory and purposive systems. Cybernetics is concerned with circular causality or feedback (e.g. where the observed outcomes of actions are taken as inputs for further action in ways that support the pursuit and maintenance of particular conditions, and/or their disruption.

Deep learning is part of a broader family of machine learning methods based on artificial neural networks with representation learning. Learning can be supervised, semi-supervised or unsupervised.

Homology is a procedure to associate a sequence of abelian groups or modules with a given mathematical object. In algebraic topology, homology refers to the procedure of computing a set of algebraic invariants of a given mathematical object. Intuitively, homology counts, for each dimension n, the n-dimensional holes of a mathematical object. For example, a two-dimensional hole is a circle inside a doughnut; a three-dimensional hole is a cavity inside a tooth, etc.

Machine Learning can be the application of Al in a way that allows the system to learn for itself through repeated iterations. It can involve the use of algorithms to parse data and learn from it. Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning.

A Publisher-Subscriber Message Bus enables the creation of a set of components/systems of event producers and consumers (e.g. named publishers and consumers). It allows various services to communicate asynchronously, with low latencies. Publisher-Subscriber Message Busses are generally used as data integration pipelines to ingest and distribute data effectively. One can efficiently distribute many tasks among many worker threads using Publisher-Subscriber Message Busses. They help in parallel processing and workflows and real-time data/event distribution.

Virtualization refers to the provision of runtime environment with certain abstractions for instruction execution components, required to perform a specific function or run an operating system. It abstracts away the physical characteristics of the underlying computing platform and provides a software/hardware interface to underlying microprocessor(s) or multiprocessor(s)

Self-referential systems contain software instructions that can alter their own instructions while they are executing. This characteristic usually helps to simplify maintenance and improve performance by reducing otherwise repetitively similar program instructions.

These definitions are provided by way of example and not of limitation.

### EXAMPLE SYSTEMS AND METHODS

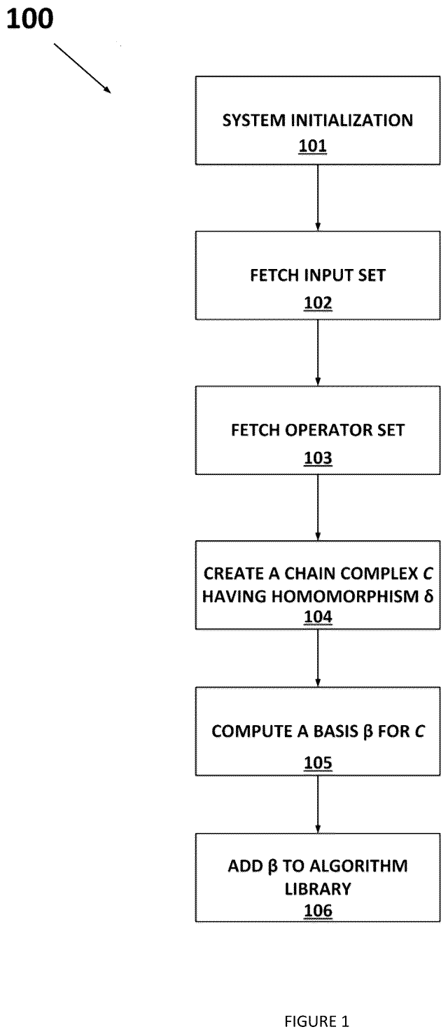

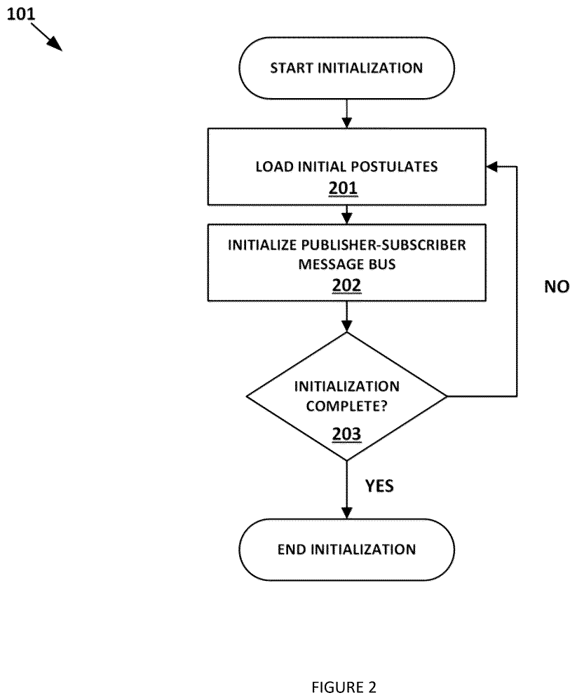

FIG. 1 illustrates an example process 100 for implementing an algorithm synthesis method using algebraic topological techniques, according to some embodiments. Process 100 can be included in an algorithm discovery/synthesis method. In step 101, the system is initialized. In some implementations, this may be a bootstrap procedure or other suitable procedure, as described in further detail with reference to FIG. 2.

In step 102, process 100 can fetch the input set(s). The input set or sets related to the example problem at hand or randomly from a pool of input sources are loaded. In step 103, process 100 can fetch the operator set(s). The operator set or sets (e.g. functions/algorithms/machine-executable instructions that can be applied on input elements) are loaded related to the example problem at hand or randomly from a knowledgebase/library of available operators.

In step 104, process 100 can create a chain C complete having a homomorphism 8. A chain complex is created that satisfies a certain rule described in further detail herein.

At step 105, process 100 computes a basis B for chain C. Basis B for the created chain complex is computed. Basis β can be representative of a generated/discovered algorithm. An alternative method to finding a basis which directly lists a generated algorithm is described in further detail infra.

At step 106, process 100 provides a basis B to the algorithm library. The discovered/generated/synthesized algorithm is added to the algorithm knowledgebase of the system. An alternate example process can containerize the whole algorithm generation operation inside a virtual machine, for example. Process 100 can add a search interface to search and find desired algorithms or specify requirements to generate an algorithm(s) on demand.

FIG. 2 illustrates an example process 200 for the initialization routine and/or bootstrap process, according to some embodiments. In step 201, process 200 loads the initial postulates. A mathematical postulates/theorems knowledgebase is loaded. These mathematical postulates/theorems can be represented/stored in the knowledgebase using a notational programming language like APL (‘A Programming Language’). Such postulates form basic mathematical truths and are expressed as mathematical equations. One such example postulate may be described as a theorem which states that the transpose of a transpose of a matrix is the matrix itself in APL language.

In step 202, process 200 initializes the publisher-subscriber message bus. A producer-consumer message queue can also be initialized. The publisher-consumer bus acts as a communication pipeline for all the system components involved in the operation (e.g. from FIG. 1).

In step 203, process 200 can determine if the initialization is complete. If ‘no’, then process 200 can return to step 201. If ‘yes’ then process 200 can proceed to ending the initialization operations.

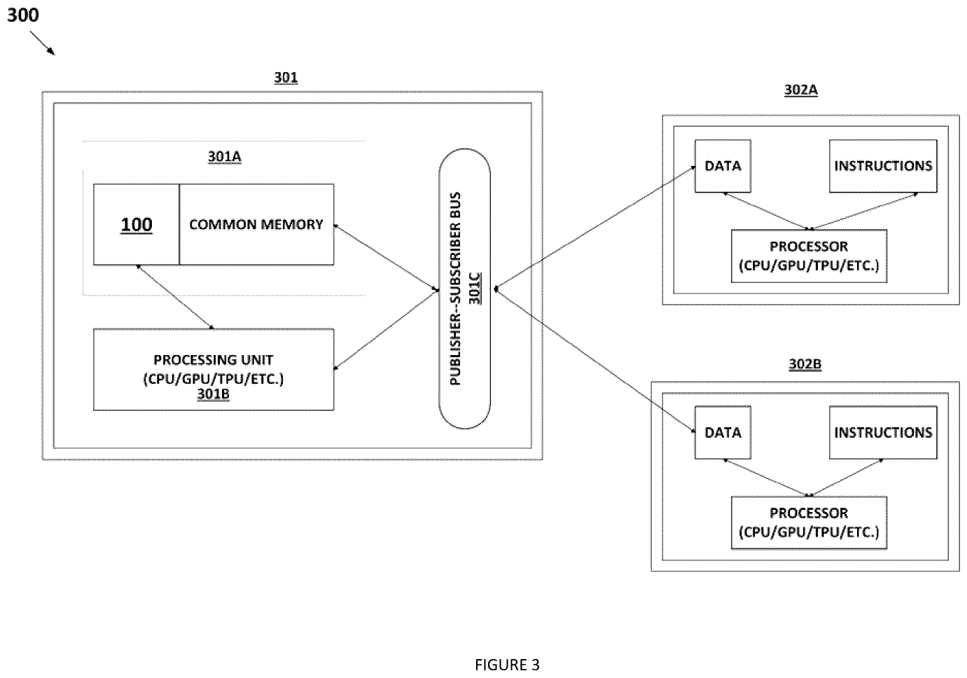

FIG. 3 illustrates an example system 300 for implementing a containerized algorithm discovery/synthesis system, according to some embodiments. In this example embodiment, a containerized system communicates with other computer systems for sharing data and issuing a remote or local procedure/function invocation. System 300 can further associate with multiple distributed memory systems. As shown in FIG. 3, system 300 include virtualized containers 301A-C and 302A-B. System 100 can reside in the computer system and may fetch input, and operator sets from its local memory and/or the publisher-subscriber bus 301 C. The connected data and processing systems 302A-B can act as servers for operator and input libraries. After fetching input and operator sets, system 100 generates/synthesizes/discovers an algorithm and publishes it on the publisher-subscriber bus. The generated/discovered/synthesized algorithm is added to the pool/library of the algorithms.

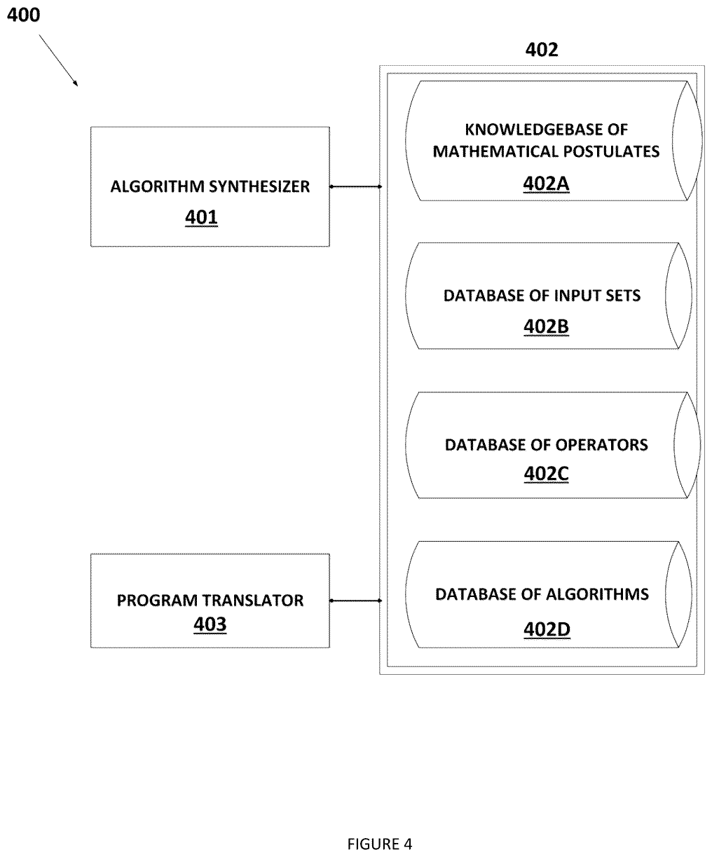

FIG. 4 illustrates an example system 400 for implementing an algorithm synthesizer on one or more knowledge component inputs, according to some embodiments. Of the invention. Algorithm synthesizer 401 can implement process 100. Algorithm synthesizer 401 can obtain inputs. Inputs can include, as shown, inter alia: input, operator, mathematical postulations, and algorithm knowledge bases. Inputs can include knowledge components 402. knowledge components 402 can include, inter alia: knowledgebase of mathematical postulates 402A, database of input sets 402B, database of operators 402C, database of algorithms 402D, etc. Program translator 403 performs programming language translation tasks. These programming language translations can be performed on the discovered/generated/synthesized algorithm from one programming language into another. This process may run in the background and/or on demand.

An example algorithm synthesizer 401 is now described in further detail. As noted, algorithm synthesizer 401 can implement process 100. Algorithm synthesizer 401 can generate and/or discover new algorithms. Given an input set and an allowed set of instructions, a chain complex is generated based on a mathematical postulation. A basis for this chain complex is calculated. This basis is split into two sets: input and instructions. Together with these two sets an algorithm is considered defined. This algorithm is added to the database of discovered/generated algorithms. As shown, algorithm synthesizer 401 is communicatively coupled with knowledgebase component 402. One exemplary interconnection and interoperation is illustrated in FIG. 3.

Algorithm synthesizer 401 can fetch inputs and operators after A system 400 initialization step. Algorithm synthesizer 401 can then assign threads to units of work within system 400 to create a chain complex, compute the basis and generate the algorithm. Depending upon need, these threads can be bundled into worker threads to represent an aggregation of enumerated tasks according to priorities as specified by mathematical postulates. These thread collections/bundles can be arbitered to various hardware like symmetric or clustered multiprocessors, streaming processors, etc.

Algorithm synthesizer 401 can be an amalgamation of continuously generated/synthesized/discovered algorithms. After system 400 is initialized with common memory and communication publisher-subscriber bus setup, a set of inputs, operators and mathematical postulates is fetched from their respective knowledge bases. The sets thus fetched are stored in memory as notations. Programming languages like, inter alia: APL, Mathematica, Maple, GAP, etc. can be utilized.

For example, the set of integers can be denoted by Z and real numbers by R. The list of allowed instructions is called operator set. For example, three operators +(add), − (subtract) and * (multiply) may be chosen as an operator set. Next, one or more mathematical postulates are fetched. These postulates dictate the nature of the synthesized/discovered/generated algorithm. One example set of mathematical postulates may be:
Let the chain complex to be created be denoted by C;
Let the function on C (i.e., its homomorphism) be denoted by δ;
An element in C should either belong to an input set, an instruction set, or an element produced by an instruction;
There exists a sequential ordering of instructions where each instruction depends on either input set, previous instructions or elements produced by previous instructions; and The input is the smallest subset among all possible inputs.

Such mathematical postulates can be codified using notational or symbolic programming languages like APL, GAP, Mathematica, Maple, etc. or logic languages like PROLOG. It is noted that many (finite) chain complexes can be constructed that satisfy these postulates and compute their basis. The basis consists of a union of three sets: J∪K∪L, where:
J=elements from the quotient group (kernel δ)/(image δ). This also referred to as homology group;

$$K = elements from the quotient group C / kernel δ ;$$

$$and$$

$$L = δ ( K ) .$$

The discovered/generated/synthesized algorithm is represented by sets J and K. J denotes the minimal input size and K is the list of instructions. The algorithm (input and instruction set) is codified in a notational language like APL. It may also be translated into other languages or machine executable instructions using language translator module 403.

Knowledgebase of operators, inputs, algorithms, and mathematical postulates (e.g. as provided in knowledge components 402) are now discussed. The database of operators (e.g. allowed instructions), inputs and mathematical postulates serve various inputs to use and a combination of one or more instructions/operators/functions allowed to be operated upon the input elements. Once a new algorithm is generated/discovered, it is added to the database of algorithms. One exemplary interconnection and interoperation between the knowledge bases and an algorithm synthesizer is illustrated in FIG. 3.

The databases which hold various input sets may like integers, real numbers, text, etc. usually store the notational code for these sets in one preferred embodiment. For example, instead of storing integers from 1 to infinity, a notation (e.g. in APL) such as (i. ∞) is stored. Similarly, various operators/functions are stored in their respective databases. A few such operators that operate on numbers and matrices could be ADD, SUBTRACT, TRANSPOSE, GREAT THAN, LESS THAN, EQUALS, SWAP, INVERSE, SORT, etc. Algorithms that are generated/discovered are also deemed as operators. The mathematical postulates hold various truisms (axioms upon which chain complexes can be built) and can be selected in plurality. It may also hold a library of various chain complexes already created along with their corresponding homomorphisms. One example of a chain complex and its homomorphism function will be described here in detail using an example use case.

An example embodiment of program translator 403 is now discussed. Once a generated algorithm is stored in the database, a program translator may be invoked to translate the algorithm into various programming languages and machine executable instructions using various methods (e.g. like neural network conversion methods, rule-specified methods, etc.).

Program translators 402 can translate APL programs into other languages like C, C++, Java, etc. Also, a support routine to the program translator can run the background that continuously searches for optimal sequence of machine instructions (e.g. custom to underlying hardware) and replaces those with generated ones.

### ADDITIONAL EXAMPLE EMBODIMENTS

The system may also manifest as an on-demand algorithm synthesizer/discoverer. To suit this purpose, a set of desired mathematical postulates is loaded and the algorithm synthesizer 401 is triggered to start with the loaded postulations. A search API can be provided to find the desired algorithm/program in case it has already been synthesized. In some examples, highly specialized processing cores may be utilized/designed to execute the instructions of both the system and the algorithms that are discovered by the system.

An example use case of system 400 is now discussed. In one example, the input can be the set of all integers. The only allowed operator can be ADD (+). The mathematical postulations provided supra can be loaded. Process 100 (and/or process 800) can create a chain complex C=0→Cₙ→Cₙ₋₁→ . . . →C₂→C₁→0 with homomorphism δ.

Let C₁=set of all integers={1, 2, 3, . . . }

Let C₂=set of all instructions={ADD}={(a1, a2)∈C₁×C₁ such that (a1 ADD a2)∈C₁

And δ((α₁, α₂))=−a₁−a₂+(a₁ ADD a₂)

Similarly, δ((a₁, a₂, . . . , aₙ))=−((a₂, . . . , aₙ))+Σᵢ₌₁ⁿ⁻¹−1ⁱ((a₁, a₂, . . . (aᵢ ADD a₁₊₁), aₙ))+−1ⁿ(a₁, a₂, . . . , aₙ₋₁).

This ensures 88=0.

Thus, computing the basis element from homology group, we get {(1)} to be the input set J and the instruction set K equals basis elements from C/(image δ)={(1, a₁, a₂, . . . , aₙ)} and (1+a1+a2+ . . . +an)<n. This instruction set, can depend on (a₁, a₂, . . . , aₙ) and produces (1+a₁, a₂, . . . , aₙ) and can be the synthesized/discovered algorithm.

Thus, applying this synthesized/discovered recursively, starting with input set {1} and setting n=5 the following can be obtained:

{1}

Add 1 to start and add all elements {1,1}→{2}

{1,2}→{3}

{1,3}→{4}

{1,4}→{5}

{1,5}→none

{1,1,1}→{2,1}

{1,1,2}→{2,2}

{1,1,3}→{2,3}

{1,1,4}→none

{1,1,5}→none

{1,2,1}→{2,2,1}

{1,2,2}→none

{2,2,1}→none

In this way, an algorithm can be synthesized/discovered that partitions a given integer n. A library of such homomorphisms and chain complexes can be calculated beforehand and added to the knowledgebase.

### Additional Methods

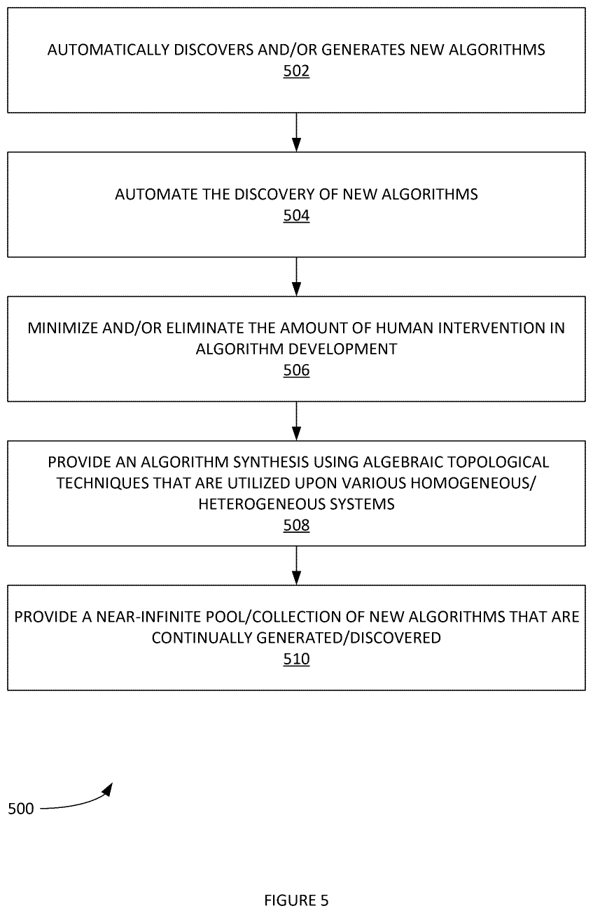

FIG. 5 illustrates an example process 500, according to some embodiments. In step 502, process 500 automatically discovers and/or generates new algorithms. In step 504, automates the discovery of new algorithms. In step 506, process 500 minimizes and/or eliminates the amount of human intervention in algorithm development (e.g. in finding and generating algorithms). In step 508, process 500 provides an algorithm synthesis using algebraic topological techniques that are utilized upon various homogeneous/heterogeneous systems (e.g. databases, operating systems, sensors, autonomous/human-controlled machinery and/or software applications). In step 510, process 500 provides a near-infinite pool/collection of new algorithms that are continually generated/discovered.

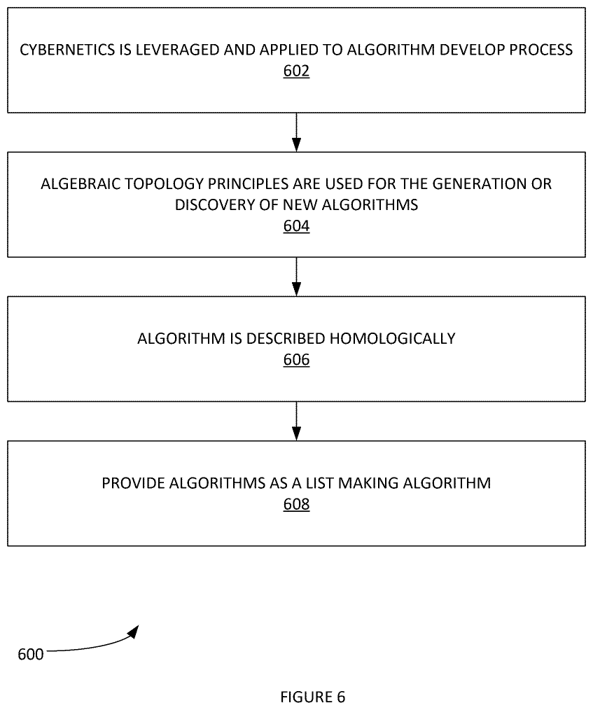

FIG. 6 describes an example process 600 providing for the generation of algorithms from first principles. In process 600, abstract algebra/algebraic topology are utilized for algorithm discovery/synthesis. In step 602, cybernetics is leveraged and applied to the algorithm development process. In step 604, algebraic topology algorithm development process. In step 604, algebraic topology principles are used for the generation or discovery of new algorithms. In step 606, an algorithm is described homologically.

It is noted that algorithms can be regarded as high-dimensional complexes. Process 600 can thus be used to describe exemplary methods (e.g. see supra) to construct such complexes and generate or discover new algorithms. The algorithms discovered/generated are of the list making kind. That is, algorithms that produce list(s) of objects of any type. Since an algorithm is a list of instructions, process 600 can provide algorithms as a list making algorithm in step 608.

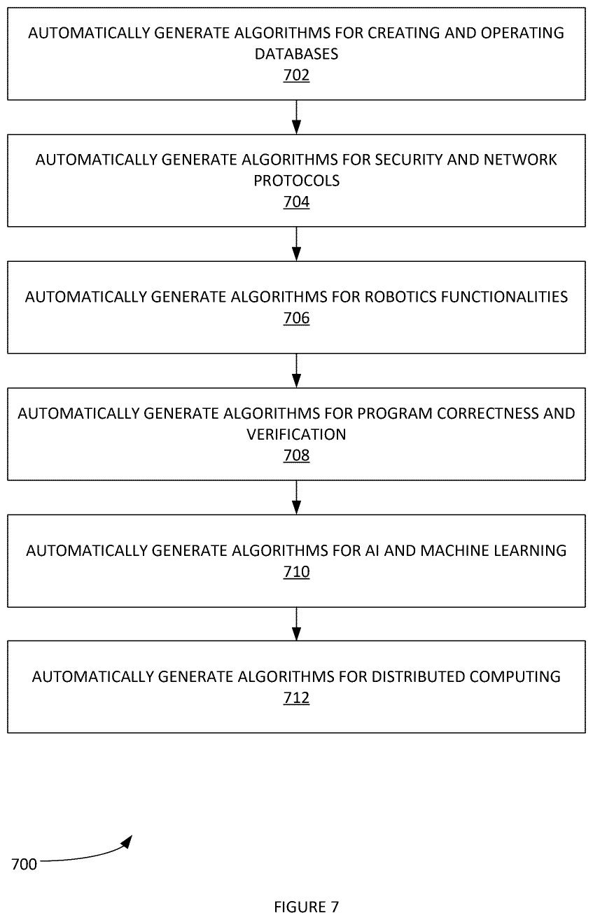

FIG. 7 illustrates an example process 700 for combining algorithms (e.g. like building blocks) to form computational systems, according to some embodiments. In step 702, process 700 can automatically generate algorithms for creating and operating databases. These algorithms can handle massively parallel database updates and fast data retrieval efficiently (and/or finding from the pool of already generated/discovered algorithms). Process 700 can describe homologically a predicate logical sentence satisfying a desired condition.

In step 704, process 700 can automatically generate algorithms for security and network protocols. Process 700 can generate new algorithms on integer factorizations and primality testing. These can help in creating new communication protocols and new ways of securing the channels (e.g. like devising new secure hashing algorithms, etc.) as these problems are a special case of primality testing and the integer factorization problem.

In step 706, process 700 can automatically generate algorithms for robotics functionalities. Issues in robotics like continuous motion planning in a geometric constraint setting can be reduced to discrete abstract algebraic problems (e.g. thus described homologically) and a suitable algorithm may be discovered/generated by the systems and methods provided herein.

In step 708, process 700 can automatically generate algorithms for program correctness and verification. Process 700 can automatically check whether a given program is correct. Since a reverse mapping of a program to an algorithm can be done homologically, and the algorithm has a corresponding topology (e.g. an algebraic topological representation), the correctness can be evaluated based on topology much faster rather than proof checkers.

In step 710, process 700 can automatically generate algorithms for Al and machine learning. For example, new pattern matching algorithms can be discovered by matching the topology of given data to the topology of the generated/available algorithm. Process 700 can have the advantage that it does not suffer from curse of dimensionality and can handle data of many dimensions. Process 700 can also help make the data query free. For example, process 700 can be used to reduce the data to sets and query for a specific question. Instead, process 700 can operate on the topology level of data and plug and play with various algorithms discovered/generated using the proposed system.

In step 712, process 700 can automatically generate algorithms for distributed computing. With process 700, the effective usage of underlying distributed and/or parallel architectures can be made possible by various insights from permutation group theory. Process 700 can use a mathematical scheme that pairs up many subcomponents (e.g. a shuffle network) and propagate the results over a set of permutations. New algorithms can be discovered/generated using process 700 can be used to devise a permutation link exchange network(s) for high performance distributed and parallel computing.

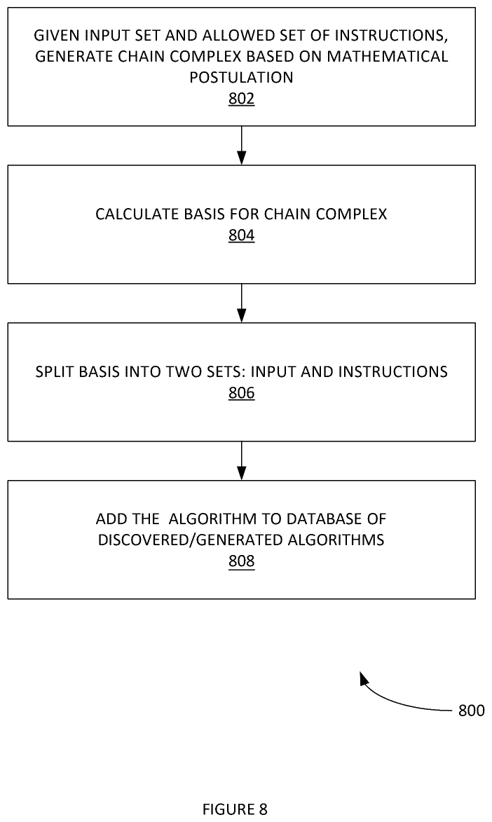

FIG. 8 illustrates an example process 800 of algorithm synthetization, according to some embodiments. In step 802, process 800 can, given an input set and an allowed set of instructions, generate a chain complex based on a mathematical postulation. In step 804, process 800 can calculate a basis for this chain complex. In step 806, process 800 can split the basis into two sets: input and instructions. Together with these two sets an algorithm is considered defined. In step 808, process 800 add the algorithm to a database of discovered/generated algorithms.

Process 800 can utilize the axiom that an algorithm is a certain homomorphism. Algorithms (e.g., a list of instructions) can be multi-dimensional. Process 800 can include a step of embedding an algorithm with a chain complex. For example, a 0-dimensional algorithm can be seen as a chain set of data elements (e.g. input, output, intermediate data results, etc.). A 1-dimensional algorithm chain is a set of algorithms that produce elements of 0-dimensional algorithm chains through the specified homomorphism. A 2-dimensional algorithm chains are meta-algorithms that produce the algorithms that produce 0-dimensional algorithms (e.g., data elements/objects), and so on.

By way of example, to bring a sense of comparison in the programming world, process 800 can represent 0-dimensional instructions as integers or floating points up to a certain finite value. 1-dimensional instructions as the machine language. 2-dimensional instructions as the assembly language. 3-dimensional instructions as higher-level programming language instructions, and so on.

Process 800 can specify a system within a system. This means, for example, that all executable machine instructions (or program instructions) in the processor may be stored within the invention as a knowledge base. In other words, the system may be self-referential, and the algorithm discovered/synthesized may also be self-referential.

In some examples, programming instructions to execute instructions in the processor (e.g. CPU, GPU or TPU) can be stored as a database. In addition to the software instructions, it may also contain necessary subsystems to produce and test various homological descriptors and other algebraic topological objects and the ability to translate these into machine executable language. Process 800 can be used to save memory/data storage space using symbols instead of saving and processing large amounts of input sets. For example, a Unicode symbol infinity can be used to denote a set of integers with cardinality infinity.

### Hardware-Implemented Topological Algorithm Generator for Network Traffic Optimization

The field of algorithm development has long been dominated by human-driven approaches that rely heavily on intuition, experience, and manual programming efforts. Embodiments of the present invention introduce a departure from these traditional methods by utilizing algebraic topology to automate the discovery and generation of algorithms. This innovation represents a paradigm shift in computational theory and applied mathematics, establishing a framework where algorithms emerge from mathematical exploration rather than deliberate human design. These algorithms can then be used to implement a hardware-implemented topological algorithm generator for network traffic optimization.

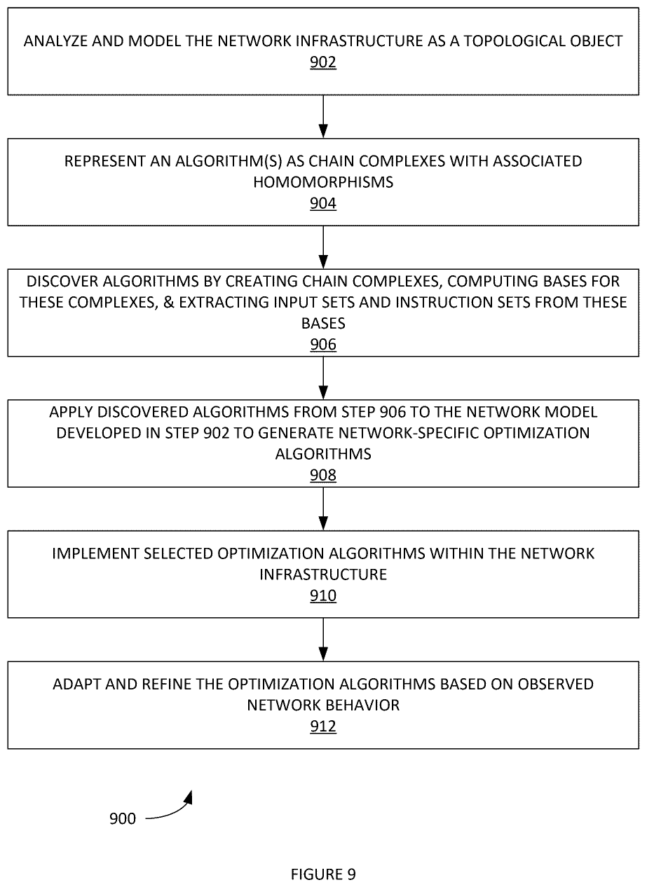

FIG. 9 illustrates an example process 900 for hardware-implemented topological algorithm generator for network traffic optimization, according to some embodiments.

Process 900 is built upon principles from cybernetics and algebraic topology. The approach conceptualizes algorithms as topological objects with homological properties. By framing algorithm discovery as a mathematical problem, process 900 translates practical, real-world problems into abstract mathematical spaces where algorithms can be discovered through formal operations rather than manually created.

In step 902, process 900 analyzes and models the network infrastructure as a topological object. Process 900 ingests network topology information, traffic patterns, quality of service requirements, and performance metrics to create a comprehensive homological representation of the network environment. This representation captures both the physical structure of the network (e.g. nodes, links, capacities) and its dynamic operational characteristics (e.g. traffic flows, congestion points, latency distributions). The following steps can then utilize this network model and process 900 can generate one or more optimized network models therefrom.

In step 904, process 900 represents an algorithm(s) as chain complexes with associated homomorphisms. These mathematical structures capture the essential characteristics of algorithms in a way that enables systematic exploration. As noted supra, different dimensional “chains” represent various levels of abstraction, from basic data elements (0-dimensional) to instructions (1-dimensional), higher-level programming constructs (2-dimensional), and beyond.

In step 906, process 900 discovers algorithms are discovered by creating chain complexes that satisfy specific mathematical postulates, computing bases for these complexes, and extracting input sets and instruction sets from these bases. This mathematical approach allows the system to identify algorithms that might remain undiscovered through conventional programming approaches, potentially yielding optimizations and novel solutions across diverse domains.

In step 908, process 900 applies the discovered algorithms from step 906 to the network model developed in step 902 to generate network-specific optimization algorithms. This step involves mapping the abstract topological structures of the discovered algorithms to the specific topological features of the network model. Process 900 evaluates multiple candidate algorithms against the network's operational requirements, selecting those that provide optimal performance for the target metrics such as throughput, latency, congestion mitigation, and quality of service.

In step 910, process 900 implements the selected optimization algorithms within the network infrastructure. This implementation may occur at various levels, including router firmware, software-defined networking controllers, traffic management systems, or dedicated network appliances. Process 900 continuously monitors network performance against established baselines, collecting real-time telemetry data to validate the effectiveness of the implemented algorithms and to feed back into the optimization process.

In step 912, process 900 adapts and refines the optimization algorithms based on observed network behavior. As the network environment evolves (e.g. with changing traffic patterns, hardware modifications, or shifting application requirements, etc.), process 900 automatically adjusts the implemented algorithms or synthesizes new algorithms to maintain optimal performance. This continuous adaptation leverages the algorithm corpus developed in previous iterations, enabling increasingly sophisticated optimization strategies that account for the complex, dynamic nature of modern network environments.

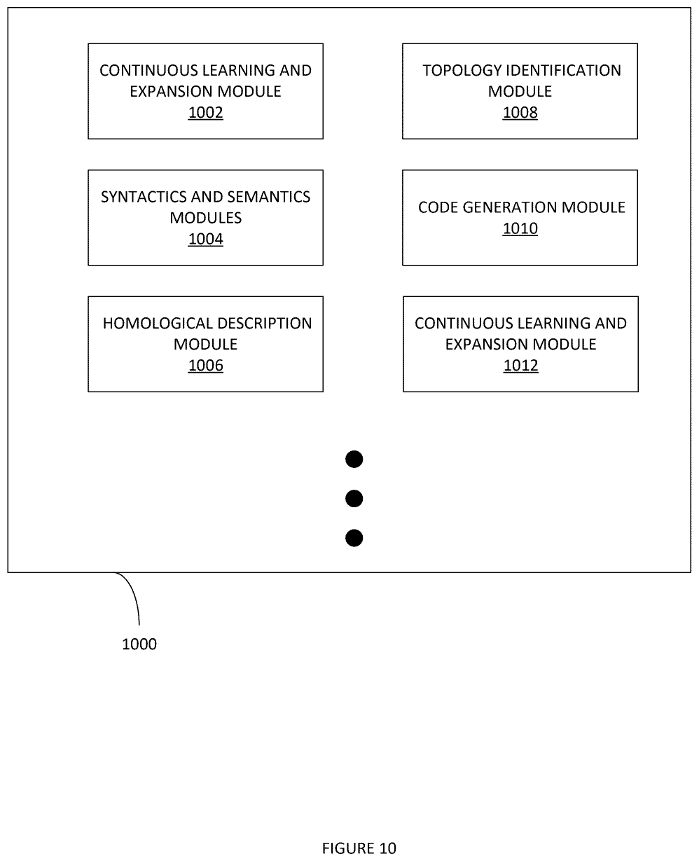

FIG. 10 illustrates an example system 1000 of an example System Architecture and Implementation for process 900, according to some embodiments. The implementation architecture supports the theoretical framework through a comprehensive system of interrelated components. The algorithm generation engine 1002 consists of specialized hardware components, including dedicated processors optimized for algebraic computations and topological analysis. This hardware architecture enables efficient exploration of mathematical spaces that would be computationally prohibitive with general-purpose processors.

Syntactics and semantics modules 1004 receives ontology information defining aspects of an enterprise domain (e.g. networking, etc.), which includes a list of types with associated attributes. It processes syntactic information rules that specify relationships between source types and target types, mirroring the object-entity relationships found in relational database systems. Complementing these syntactic rules, the system also handles semantic rules that specify bidirectional relationships between attributes of various types.

In homological description module 1006, both the syntactic and semantic rules undergo a transformation process that converts them into homological descriptions, creating mathematical representations that can be processed within the topological framework. The ontological information is similarly transformed into homological descriptions, establishing a comprehensive mathematical model of the problem domain.

With these homological representations in place, topology identification module 1008 conducts a sophisticated search within the homological space to identify a topology that matches or approximates the given homological descriptions. When a suitable topological object is discovered, code generation module 1010 translates it back into executable code, completing the cycle from problem specification to algorithmic solution.

System 1000 can provide a containerized implementation where various components communicate via publisher-subscriber message buses. This architecture allows for distributed processing across multiple systems, with specialized components handling different aspects of the algorithm discovery process. System 1000 includes mechanisms for initializing with mathematical postulates, fetching input and operator sets, creating chain complexes, computing bases, and integrating discovered algorithms into a knowledge base.

Continuous Learning and Expansion module 1012 provides a capacity for continuous learning and expansion of capabilities. When a topological object is discovered through the search process, both the object itself and its associated homological information are added to a corpus of algorithms maintained by the system. This growing collection serves as a repository of knowledge that can be leveraged in future searches.

The discovered algorithms are not merely stored as isolated solutions but are treated as compound functional units that can aid in the search for higher-order algorithms. This approach enables the system to build upon its past discoveries, potentially identifying increasingly sophisticated algorithms over time. The cumulative nature of this process represents a form of machine learning that differs from conventional approaches, as it builds a growing mathematical understanding of algorithmic structures and relationships rather than learning from statistical patterns in data.

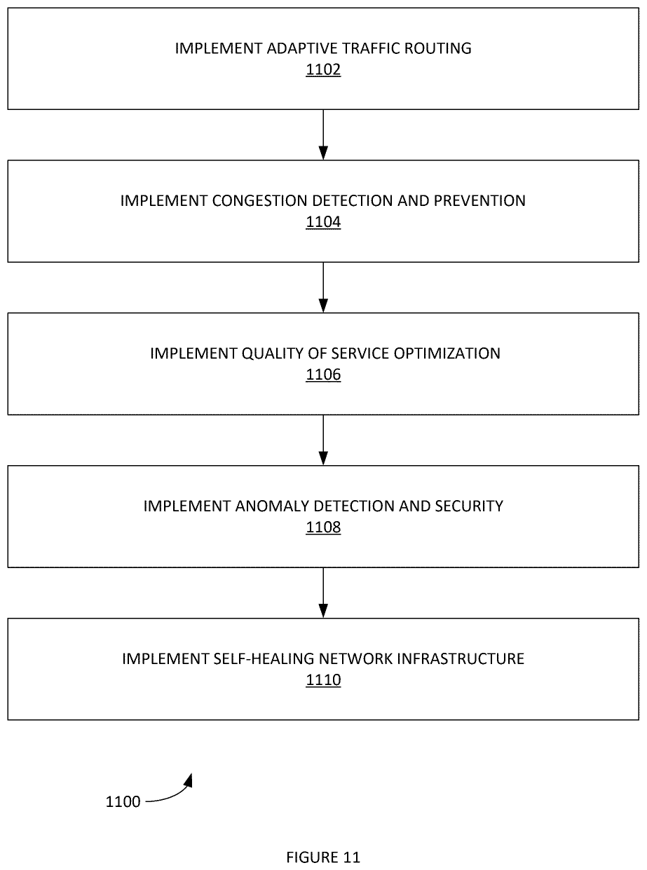

FIG. 11 illustrates an example process 900 for applications in Network Traffic Management, according to some embodiments. Process 900 for applications in Network Traffic Management for process 900 and system 1000 are now discussed by way of example. A particularly promising application of this technology is in the field of network traffic management. Computer networks face increasingly complex challenges with the growth of internet traffic, diverse application requirements, and sophisticated cyber threats. Traditional approaches to network traffic management often rely on handcrafted algorithms that struggle to adapt to rapidly changing network conditions and new types of traffic patterns. The algorithm synthesis system can thus significantly improve network traffic management through topological algorithm generation in several key ways in process 1100. Process 1100 can use process 900 and 1000 to implement the following steps.

In step 1102, process 1100 can implement Adaptive Traffic Routing. By analyzing the topological properties of network traffic flows, process 1100 can discover algorithms that optimize routing decisions in real-time. These algorithms can dynamically adjust to changing network conditions, ensuring efficient utilization of available bandwidth and minimizing latency.

In step 1104, process 1100 can implement Congestion Detection and Prevention. Process 1100 can generate algorithms that detect emerging congestion patterns before they become problematic. By representing network traffic as topological objects, the system can identify subtle changes in traffic flow that indicate potential congestion points and generate preemptive measures to alleviate them.

In step 1106, process 1100 can implement Quality of Service Optimization. Different network applications have varying requirements for bandwidth, latency, and reliability. The algorithm synthesis system can discover sophisticated algorithms that balance these competing demands, ensuring optimal quality of service for all applications according to their specific needs.

In step 1108, process 1100 can implement Anomaly Detection and Security. Network security threats often manifest as anomalies in traffic patterns. The topological approach is particularly well-suited to detecting such anomalies, as it can identify unusual relationships and patterns that might indicate security breaches or attacks. Process 1100 can generate specialized algorithms for identifying and mitigating specific types of network threats.

In step 1110, process 1100 can implement Self-Healing Network Infrastructure. When network failures occur, process 1100 can discover algorithms that automatically reroute traffic around damaged components while maintaining optimal performance. These algorithms can adapt to the specific topology of the network and the nature of the failure, providing more effective recovery than generic approaches.

Implementation of these topologically generated algorithms in network infrastructure can lead to significant improvements in performance, reliability, and security. Network operators can deploy these algorithms in routers, switches, and other network devices, either as firmware updates or as part of software-defined networking (SDN) controllers.

For example, a network operator managing a large data center might use the system to discover algorithms specifically tailored to their unique network topology and traffic patterns. These algorithms could continuously adapt as the network evolves, ensuring optimal performance without requiring constant human intervention. The system could also generate specialized algorithms for handling periodic traffic spikes, such as those that occur during major online events or sales.

Additional Applications and Implications are now discussed as processes 900, 1100 and system 1000 can be adapted to other use cases. Beyond network traffic management, the algorithm synthesis approach has numerous other potential applications. In automotive systems, the approach can generate algorithms that optimize engine performance based on real-time sensor data, reducing emissions and improving fuel efficiency. The system can discover algorithms that adapt to specific vehicle characteristics and driving conditions, providing more effective optimization than generic control algorithms.

For robotics applications, adapted versions of processes 900, 1100 and system 1000 can generate motion planning algorithms that navigate complex environments while satisfying various constraints. By representing the physical space as a topological object, the system can discover efficient algorithms for path planning, obstacle avoidance, and coordinated movement among multiple robots.

For machine learning applications, adapted versions of processes 900, 1100 and system 1000 can generate specialized training algorithms that adapt to the specific characteristics of the data and the learning task. These algorithms can potentially overcome limitations of current approaches, such as the need for extensive hyperparameter tuning or vulnerability to adversarial examples.

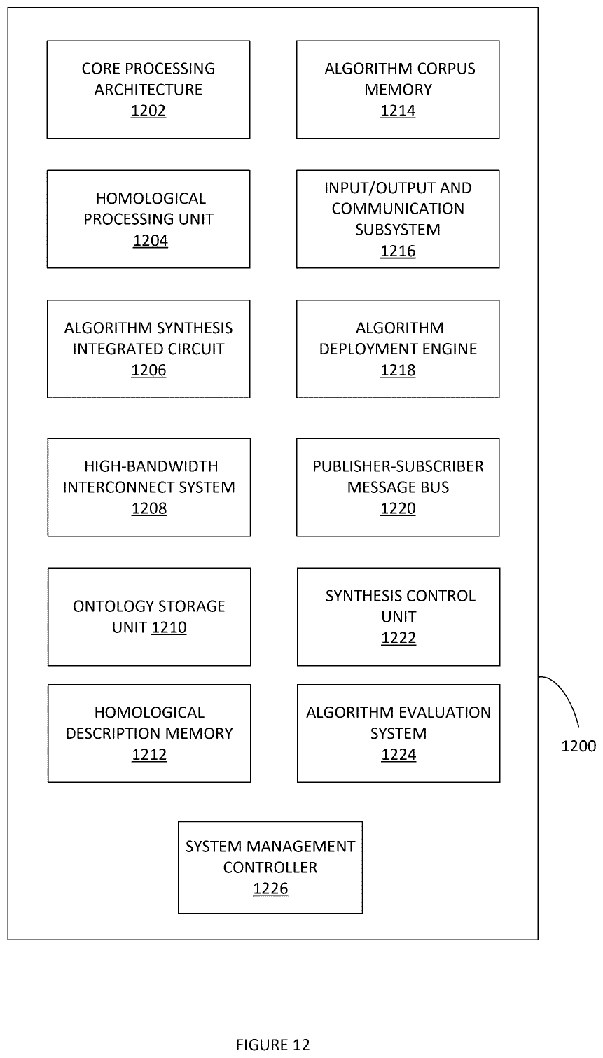

FIG. 12 illustrates an example hardware system 1200 for implementing hardware-implemented topological algorithm generator for network traffic optimization, according to some embodiments. Hardware system 1200 uses automated algorithm synthesis using algebraic topology. Hardware system 1200 is a specialized hardware system designed to efficiently perform the complex mathematical operations required for topological analysis and algorithm discovery. Hardware system 1200 includes an architecture that integrates multiple specialized components working in concert to enable high-performance algorithm synthesis, particularly for demanding applications such as network traffic management.

Core Processing Architecture 1202 is a specialized processing unit, the Topological Algorithm Synthesis Engine (TASE). Core Processing Architecture 1202 can include the following components.

Homological Processing Units (HPUs) 1204 can be an array of custom-designed processing elements optimized for performing algebraic topology operations. Homological Processing Units (HPUs) 1204 can contain specialized circuitry for computing chain complexes, homomorphisms, and basis calculations, implementing matrix operations and linear algebra functions in hardware. Each HPU contains, inter alia:

Multiple parallel arithmetic logic units optimized for homological calculations;

Dedicated memory for storing mathematical structures like matrices and vector spaces; and

Custom instruction sets specifically designed for topological operations.

Algorithm Synthesis Integrated Circuit (ASIC) 1206 can be an application-specific integrated circuit designed to accelerate the algorithm synthesis process. The ASIC 1206 contains, inter alia:

Multiple neuron arrays organized in a hierarchical structure, each neuron comprising a register, a microprocessor, and multiple inputs;

A network of synaptic circuits, each including memory for storing synaptic weights;

Dedicated hardware for pattern recognition and solution space exploration; and

Custom logic for translating mathematical objects into algorithmic structures.

High-Bandwidth Interconnect System 1208 can be a specialized interconnect fabric that enables high-speed, low-latency communication between the various components of the hardware system. This interconnect supports, inter alia:

Direct memory access for rapid transfer of large mathematical structures;

Priority-based routing to ensure time-critical operations receive necessary resources; and

Configurable topology to adapt to the specific requirements of different problem domains.

Memory Hierarchy is now discussed. Hardware system 1200 implements a specialized memory hierarchy designed to support the unique requirements of topological algorithm synthesis. Ontology Storage Unit (OSU) 1210 includes a High-capacity, non-volatile storage for maintaining detailed representations of problem domains, including type hierarchies, attributes, and relationships. The OSU 1210 includes, inter alia:

Content-addressable memory for rapid retrieval of domain-specific information;

Dedicated indexing hardware for efficient querying of type relationships; and

Versioning support to track the evolution of domain ontologies.

Homological Description Memory (HDM) 1212 can be an ultra-fast, high-bandwidth memory dedicated to storing and manipulating homological descriptions derived from domain ontologies. The HDM 1212 features, inter alia:

Multiple parallel access ports to support simultaneous operations by multiple HPUs; hardware support for sparse matrix representations common in topological descriptions; and direct mapping capabilities to translate between domain concepts and their homological representations.

Algorithm Corpus Memory (ACM) 1214 can be a hierarchical storage system for maintaining the growing knowledge base of discovered algorithms and their associated topological structures. The ACM includes, inter alia: tiered storage with different performance characteristics for frequently and infrequently accessed algorithms; hardware-accelerated search capabilities for identifying relevant existing algorithms; and dedicated compression/decompression engines optimized for algorithm representations.

Input/Output and Communication Subsystem 1216 can be used to facilitate integration with external systems and enable practical deployment of synthesized algorithms. Input/Output and Communication Subsystem 1216 includes specialized I/O and communication components. Input/Output and Communication Subsystem 1216 can include Domain Interface Adapters as configurable hardware interfaces that connect to specific problem domains, such as network infrastructure. These adapters include: protocol-specific accelerators for common networking protocols; real-time data acquisition circuits for capturing domain-specific metrics; and hardware-level filtering and pre-processing to reduce computational load on the core system.

Algorithm Deployment Engine 1218 is a specialized subsystem for translating synthesized algorithms into executable code for target platforms and deploying them to production environments. Algorithm Deployment Engine 1218 includes hardware translation units for common programming languages and execution environments. Algorithm Deployment Engine 1218 includes verification circuitry to ensure correct implementation of the algorithm's mathematical properties. Algorithm Deployment Engine 1218 includes secure delivery channels for deploying algorithms to critical infrastructure.

Publisher-Subscriber Message Bus 1220 can be a hardware-implemented communication system that enables efficient, asynchronous communication between the various components of the system. Publisher-Subscriber Message Bus 1220 includes a dedicated message routing logic to ensure messages reach their intended recipients. Publisher-Subscriber Message Bus 1220 includes a quality-of-service guarantees for time-critical communications. Publisher-Subscriber Message Bus 1220 includes a hardware-level filtering to direct messages based on content and priority.

System Integration and Management is now discussed. Hardware system 1200 is coordinated and managed by several specialized components. Hardware system 1200 include a Synthesis Control Unit (SCU) 1222. Synthesis Control Unit (SCU) 1222 is a dedicated controller that orchestrates the algorithm synthesis process, allocating resources and coordinating the activities of the various subsystems. The SCU 1222 includes a hardware scheduler for assigning computational tasks to available resources. The SCU 1222 performance monitoring circuits to identify bottlenecks and optimize resource allocation. The SCU 1222 adaptive control logic to modify synthesis strategies based on results and system state.

Algorithm Evaluation System 1224 uses specialized hardware for assessing the quality and performance of synthesized algorithms against predefined criteria. Algorithm Evaluation System 1224 includes simulation accelerators for testing algorithms in virtual environments. Algorithm Evaluation System 1224 includes comparative analysis circuits for benchmarking against existing solutions. Algorithm Evaluation System 1224 includes feedback channels to guide refinement of synthesis parameters.

System Management Controller 1226 is a secure, resilient control system that manages the overall operation of the hardware, including power management, fault detection and recovery, and system configuration. System Management Controller 1226 includes hardware security modules to protect the integrity of the synthesis process. System Management Controller 1226 includes thermal management systems to ensure optimal operating conditions. System Management Controller 1226 includes redundant control paths to maintain system availability during component failures.

The physical implementation of the hardware system 1200 can take several forms depending on deployment requirements. In one example, hardware system 1200 can include a Rack-Mounted Appliance. For large-scale enterprise or data center deployments, hardware system 1200 can be implemented as a dedicated rack-mounted appliance containing multiple interconnected processing modules, with redundant power supplies and cooling systems.

Hardware system 1200 can include PCIe Accelerator Cards. For integration with existing server infrastructure, key components of the system can be implemented as PCIe accelerator cards, enabling standard servers to offload topological processing tasks to specialized hardware. Hardware system 1200 can include Network Equipment Integration. For direct deployment in network infrastructure, essential components can be integrated into switches, routers, and other network equipment, enabling real-time algorithm synthesis and adaptation based on network conditions.

Hardware system 1200 can have a distributed implementation. For large-scale applications, hardware system 1200 can be implemented as a distributed collection of specialized hardware units connected via high-speed networks, enabling massive parallelism in the algorithm synthesis process.

This hardware system 1200 provides the computational foundation necessary to realize the full potential of algorithm synthesis through algebraic topology, particularly for demanding applications like network traffic management where real-time performance and adaptability are essential.

Network-specific examples of network traffic optimization using topological algorithm synthesis are now provided. The topological algorithm synthesis systems and methods provided herein can generate specialized algorithms for network traffic optimization that address specific challenges in modern network environments. Here are various examples of how the system can be applied to concrete network traffic management problems using processes 900 and 1100 and systems 1000 and 1200.

Data Center Congestion Management can be optimized using processes 900 and 1100 and systems 1000 and 1200 (and/or additional information provided supra). A large services data centers can experience predictable but complex traffic patterns related to market opening/closing, end-of-day processing, and quarterly reporting cycles. Traditional static congestion management algorithms struggle to adapt. Systems 1000 and 1200 analyzes historical traffic data as a time-varying topological space, identifying patterns that human operators miss. Systems 1000 and 1200 generate an algorithm that, inter alia: preemptively reconfigures traffic paths 3-5 minutes before predicted congestion events, creates dynamically sized “traffic lanes” based on packet classification and/or implements a nested priority system with 16 levels instead of the standard 8. Systems 1000 and 1200 can incorporates feedback loops that adjust buffer allocations in network switches based on application-level performance metrics.

Systems 1000 and 1200 can implement Multi-Path TCP Optimization. A content delivery network (CDN) may use Multi-Path TCP (MPTCP) to distribute traffic across multiple paths. However, standard MPTCP congestion control algorithms do not account for the specific topology of their network and backbone provider connections. Systems 1000 and 1200 can implement a Topological Solution. Systems 1000 and 1200 can model the network as a weighted graph with time-varying edge properties, then discovers an algorithm that, inter alia: dynamically adjusts subflow creation based on real-time path quality measurements; implements packet scheduling that considers both current path conditions and application requirements; creates a predictive model for path degradation based on historical patterns; and/or incorporates cross-layer information from application, transport, and network layers.

Systems 1000 and 1200 can optimize IoT Gateway Traffic Prioritization. An industrial IoT deployment with thousands of sensors generates heterogeneous traffic with varying importance and time-sensitivity requirements. Standard QoS mechanisms are too rigid for the dynamic nature of the environment. Systems 1000 and 1200 can implement various Topological Solutions. Systems 1000 and 1200 can represent the traffic classification problem as a high-dimensional topological space and generates an algorithm that, inter alia: create an adaptive classification system that evolves based on operational patterns; implement a context-aware packet scheduler that considers both current network conditions and the semantic importance of different data types; develops specialized queuing disciplines for different traffic categories; and/or incorporates failure prediction to preemptively reroute critical traffic

Systems 1000 and 1200 can implement 5G Network Slicing Optimization. A telecommunications provider implementing network slicing in their 5G infrastructure needs to dynamically allocate resources across multiple virtual networks with diverse requirements (e.g. eMBB, URLLC, mMTC). Systems 1000 and 1200 implement a Topological Solution. Systems 1000 and 1200 can model the resource allocation problem as a multi-dimensional topological manifold and generates an algorithm that, inter alia: implements real-time resource reallocation based on usage patterns and SLA requirements; creates dynamic boundaries between network slices that adjust based on current loads; develops predictive models for resource needs based on spatial and temporal patterns; and/or incorporates multi-objective optimization to balance competing demands.

Systems 1000 and 1200 can optimize DDOS Defense and Mitigation. A cloud service provider faces increasingly sophisticated DDOS attacks that evade traditional detection and mitigation techniques by mimicking legitimate traffic patterns. Systems 1000 and 1200 implement a Topological Solution. Systems 1000 and 1200 can analyze traffic flows as a dynamic simplicial complex and generates a defense algorithm that, inter alia: identify topological signatures of attack traffic that aren't visible in traditional statistical analyses; create adaptive filtering rules based on subtle correlations across multiple traffic parameters; and/or implements a multi-stage detection pipeline with progressive refinement. Systems 1000 and 1200 can also develop targeted rate-limiting that preserves legitimate traffic while throttling attack flows.

Systems 1000 and 1200 can implement Software-Defined WAN Routing. It is noted that multinational corporation with offices in thirty-seven (37) countries needs to optimize their SD-WAN traffic routing across a complex mesh of MPLS, broadband internet, and cellular backup connections. Systems 1000 and 1200 can implement a Topological Solution. Systems 1000 and 1200 model the global network as a weighted, directed graph with stochastic edge properties and generates a routing algorithm that, inter alia: creates application-specific routing policies based on performance requirements and network conditions; implements predictive path selection based on historical performance patterns; develop automated failover sequences tailored to specific application requirements; and/or incorporates cost optimization while maintaining performance SLAs.

These examples demonstrate how the topological algorithm synthesis approach can address specific network traffic optimization challenges with tailored, adaptive solutions that surpass the capabilities of traditional, human-designed algorithms. By representing network problems as topological spaces and discovering algorithms through mathematical exploration, the system can identify novel approaches to complex traffic management issues across a wide range of network environments and use cases.

### ADDITIONAL COMPUTING SYSTEMS

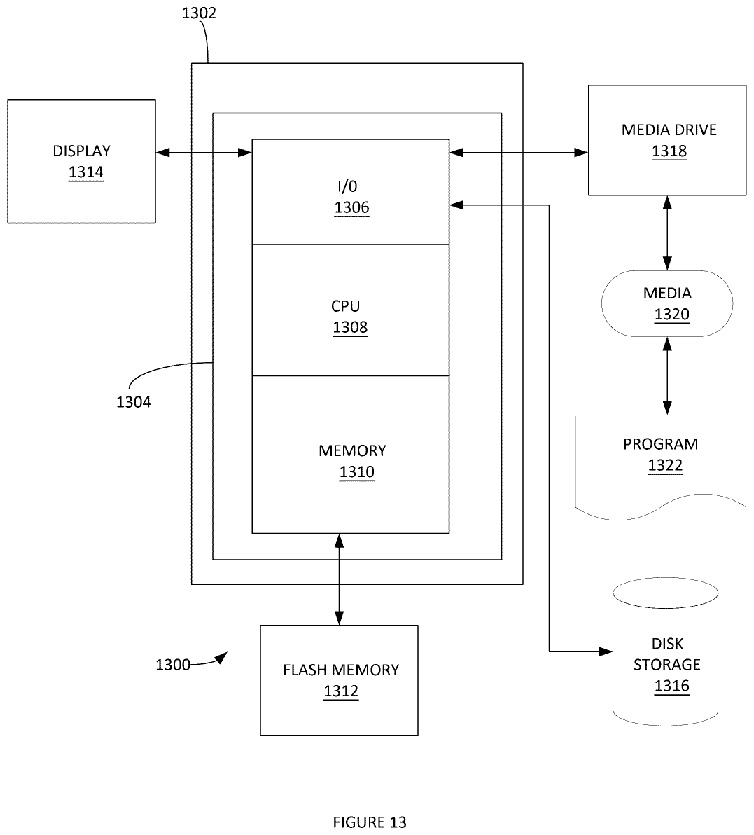

FIG. 13 depicts an exemplary computing system 1300 that can be configured to perform any one of the processes provided herein. In this context, computing system 1300 may include, for example, a processor, memory, storage, and I/O devices (e.g., monitor, keyboard, disk drive, Internet connection, etc.). However, computing system 1300 may include circuitry or other specialized hardware for carrying out some or all aspects of the processes. In some operational settings, computing system 1300 may be configured as a system that includes one or more units, each of which is configured to carry out some aspects of the processes either in software, hardware, or some combination thereof.

FIG. 13 depicts computing system 1300 with a number of components that may be used to perform any of the processes described herein. The main system 1302 includes a motherboard 1304 having an I/O section 1306, one or more central processing units (CPU) 1308 and/or graphical processing unit (GPU), and a memory section 1310, which may have a flash memory card 1312 related to it. The I/O section 1306 can be connected to a display 1314, a keyboard and/or another user input (not shown), a disk storage unit 1316, and a media drive unit 1318. The media drive unit 1318 can read/write a computer-readable medium 1320, which can contain programs 1322 and/or databases. Computing system 1300 can include a web browser. Moreover, it is noted that computing system 1300 can be configured to include additional systems in order to fulfill various functionalities. Computing system 1300 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

1. A method for automated algorithm synthesis, comprising:
applying cybernetic principles to an algorithm development process;
receiving ontology information defining aspects of a problem domain, the ontology information including a list of types and associated attributes;
transforming the ontology information into homological descriptions;
creating a chain complex based on mathematical postulates, wherein the chain complex satisfies predefined homomorphism rules;
computing a basis for the chain complex; partitioning the basis into an input set and an instruction set to define a synthesized algorithm;
adding the synthesized algorithm to an algorithm knowledge base; and
executing the synthesized algorithm to solve a problem in the problem domain.

2. The method of claim 1, wherein the problem domain is network traffic management, and wherein executing the synthesized algorithm comprises at least one of: routing network traffic, detecting network congestion, optimizing quality of service, detecting network anomalies, or rerouting traffic around network failures.

3. The method of claim 1, further comprising: receiving syntactic information rules specifying relationships between source types and target types in the problem domain; receiving semantic rules specifying bidirectional relationships between attributes of various types; and transforming the syntactic information rules and semantic rules into homological descriptions prior to creating the chain complex.

4. The method of claim 1, wherein adding the synthesized algorithm to the algorithm knowledge base comprises: storing the topological object corresponding to the synthesized algorithm; storing the associated homological information; and designating the synthesized algorithm as a compound functional unit available for use in discovering higher-order algorithms.

5. The method of claim 1, further comprising: searching the algorithm knowledge base for existing algorithms related to the problem domain; incorporating relevant existing algorithms as components in creating the chain complex; and modifying the mathematical postulates based on properties of the existing algorithms.

6. The method of claim 1, wherein computing the basis for the chain complex comprises: calculating elements from a quotient group defined by a kernel and image of the homomorphism of the chain complex; determining elements from a quotient group of the chain complex divided by the kernel; and computing the homological group of the chain complex.

7. The method of claim 1, further comprising translating the synthesized algorithm into executable code in a target programming language using a program translator.

8. The method of claim 1, wherein the mathematical postulates dictate that: an element in the chain complex either belongs to the input set, the instruction set, or an element produced by an instruction; there exists a sequential ordering of instructions where each instruction depends on either the input set, previous instructions, or elements produced by previous instructions; and the input set is the smallest subset among all possible inputs.

9. The method of claim 1, wherein creating the chain complex further comprises: assigning threads to units of work to create the chain complex; bundling the threads into worker threads according to priorities specified by the mathematical postulates; and distributing the worker threads across multiple hardware processors for parallel computation.

10. The method of claim 1, wherein executing the synthesized algorithm comprises: monitoring performance of the synthesized algorithm in solving the problem in the problem domain; comparing the performance to predefined performance metrics; modifying the homological descriptions based on the performance comparison; and iteratively repeating the creating, computing, partitioning, and adding steps to generate an improved synthesized algorithm.
